(19) United States
(12) Patent Application Publication
(10) Pub. No.: US 2026/0330871 A1
(43) Pub. Date: Oct. 22, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: KIMIMARU KATO, Tokyo (JP)

(21) Appl. No.: 19/637,941

(22) Filed: Apr. 2, 2026

(30) Foreign Application Priority Data
Apr. 18, 2025 (JP) 2025-069035

(51) Int. Cl. G06V 40/16; G06F 21/32; G06V 40/40; G06V 40/60

(52) U.S. Cl. CPC G06V 40/172; G06F 21/32; G06V 40/45; G06V 40/63

(57) ABSTRACT

A living body determination apparatus acquires a facial image including a face of a subject, executes authentication processing for identifying an individual by using the facial image, presents a motion instruction generated by using a first trained model, acquires a moving image including the subject after presenting the motion instruction, determines, as a first determination, that the subject has performed a motion in accordance with the motion instruction using the motion instruction and the moving image including the subject, and determines, as a second determination, that the subject included in the moving image is not a fake after authenticating that the subject is a pre-registered individual by performing authentication processing that uses the facial image of the subject when it is determined, in the first determination, that the subject has performed the motion in accordance with the motion instruction.

### BACKGROUND

### Field of the Technology

The present disclosure relates to an image processing apparatus, an image processing method, and a storage medium.

### Description of the Related Art

In recent years, methods of identity verification have been developed, including a facial recognition technique for identifying a person (hereinafter referred to as a recognition target) using a captured image of the person. Further, as a countermeasure against impersonation, i.e., impersonating a registered user by using a photograph, facial recognition systems sometimes include a function that determines whether a recognition target included in a captured image is a living body. For example, this function is executed by asking the recognition target to perform a specific motion such as blinking his/her eyes or turning his/her head and checking whether the specific motion has been performed based on an image.

Japanese Patent Laid-Open No. 2022-099130 discloses a method of asking a user to perform a plurality of motions in a random combination and random order to prevent the user from easily passing the authentication processing of using living body determination.

However, impersonation is becoming complex along with the rapid technological advancement in recent years, and thus further improvement in countermeasures against the impersonation is required.

### SUMMARY

The present disclosure is directed to a technique for further improving countermeasures against impersonation in living body determination.

According to an aspect of the present disclosure, a living body determination apparatus includes a first acquisition unit configured to acquire a facial image including a face of a subject, an authentication unit configured to execute authentication processing for identifying an individual by using the facial image, a presenting unit configured to present a motion instruction generated by using a first trained model, a second acquisition unit configured to acquire a moving image including the subject after presenting the motion instruction, a first determination unit configured to determine whether the subject has performed a motion in accordance with the motion instruction, based on the motion instruction and the moving image including the subject, and a second determination unit configured to determine that the subject included in the moving image is not a fake after authenticating that the subject is a pre-registered individual by the authentication unit, in a case where it is determined that the subject has performed the motion in accordance with the motion instruction by the first determination unit.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a hardware configuration of a living body determination apparatus according to a first embodiment.

FIG. 2 is a block diagram illustrating an example of a functional configuration of the living body determination apparatus according to the first embodiment.

FIG. 3 is a conceptual diagram illustrating a state where a user uses the living body determination apparatus according to the first embodiment.

FIG. 4 is a flowchart illustrating living body determination processing according to the first embodiment.

FIG. 5 is a flowchart illustrating motion instruction generation processing according to the first embodiment.

FIG. 6 is a flowchart illustrating determination processing for determining whether a motion according to the first embodiment has been performed.

FIG. 7 is a diagram illustrating a user interface (UI) presented to a user, according to the first embodiment.

FIG. 8 is a block diagram illustrating an example of a functional configuration of a living body determination apparatus according to a second embodiment.

FIG. 9 is a flowchart illustrating living body determination processing according to the second embodiment.

FIG. 10 is a flowchart illustrating processing for generating an example moving image based on a motion instruction according to the second embodiment.

FIG. 11 is a flowchart illustrating determination processing for determining whether a motion according to the second embodiment has been performed.

FIG. 12 is a block diagram illustrating an example of a functional configuration of a living body determination apparatus according to a second embodiment.

FIG. 13 is a block diagram illustrating an example of a functional configuration of a living body determination apparatus according to a third embodiment.

FIG. 14 is a flowchart illustrating determination processing for determining whether a motion according to the second embodiment has been performed.

FIG. 15 is a diagram illustrating a UI presented to a user according to the second embodiment.

FIG. 16 is a flowchart illustrating motion instruction generation processing according to a fourth embodiment.

FIG. 17 is a flowchart illustrating living body determination processing according to the fourth embodiment.

FIG. 18 is a flowchart illustrating processing for training a determiner for determining whether a motion according to the fourth embodiment has been performed.

FIG. 19 is a flowchart illustrating determination processing for determining whether a motion according to the fourth embodiment has been performed.

### DESCRIPTION OF THE EMBODIMENTS

Hereinafter, embodiments of the present disclosure are described with reference to the appended drawings. The embodiments described below are not intended to limit the present disclosure according to the scope of the appended claims. Although a plurality of features is described in the embodiments, not all of the plurality of features are essentially required for the present disclosure, and the plurality of features may be combined optionally. Further, in the appended drawings, the same reference numerals are applied to constituent elements identical or similar to each other, and duplicative descriptions are omitted.

### First Embodiment

In the present embodiment, text describing a motion used for living body determination is generated by utilizing a large language model such that this text is presented to a recognition target which then performs a motion corresponding to the text. Then, living body determination is executed by inputting, to a trained model, an image in which a motion performed by the recognition target is captured and the generated text which describes the motion instruction. As a result, this living body determination includes improved impersonation countermeasures such that the determination of the living body cannot be easily impersonated.

Impersonation occurs when a user uses a moving image that is similar to the recognition target in an attempt to impersonates an individual. In the present disclosure, documents used for impersonation will be referred to as fake moving images, fake images, or fake documents.

A large language model according to the present disclosure is generally referred to as “Generative Artificial Intelligence (AI)”.

In the present disclosure, a recognition target is also referred to as a user.

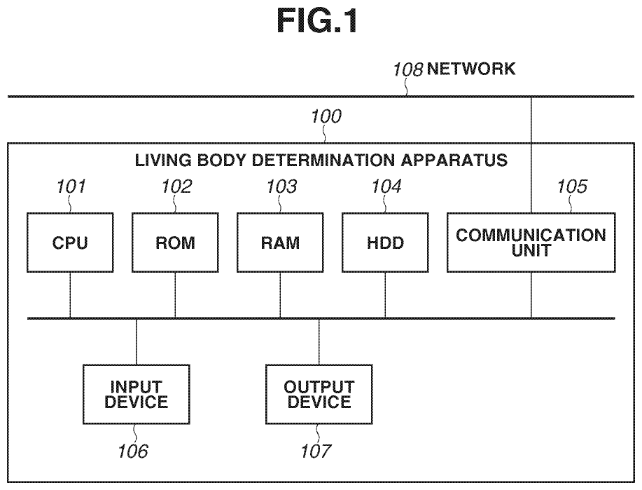

FIG. 1 is a block diagram illustrating an example of a hardware configuration of a living body determination apparatus 100 according to the present embodiment. The living body determination apparatus 100 includes a central processing unit (CPU) 101, a read only memory (ROM) 102, a random access memory (RAM) 103, a hard disk drive (HDD) 104, a communication unit 105, an input device 106 and an output device 107. The communication unit 105 is connected to a network 108.

The CPU 101 reads a control program stored in the ROM 102 and executes various types of processing. The RAM 103 is used as a main memory or a temporary storage area such as a work area. The HDD 104 is used to retain data for a long term. The communication unit 105 is a circuit that executes communication via the network 108. The input device 106 is a device for inputting instructions or data to the living body determination apparatus 100 from the outside. Specifically, the input device 106 includes a camera for acquiring a moving image and devices for receiving input from the user, such as a keyboard, a mouse, a microphone, and a touch panel. The output device 107 is a device for outputting instructions or data to the outside from the living body determination apparatus 100. Specifically, the output device 107 is a display device such as a display for displaying information to the user, a speaker for outputting a sound, and an interface for outputting information such as a living body determination result to an external apparatus.

In addition, if it is not functionally required, the living body determination apparatus 100 does not always have to have all of the constituent elements illustrated in FIG. 1. For example, the input device 106 and the output device 107 are not necessary if input/output of information with respect to an external apparatus is completely executed by another device mutually connected to the network 108.

Further, the living body determination apparatus 100 may include an element not illustrated in FIG. 1. For example, moving image processing may be executed by a graphical processing unit (GPU) or a field programmable gate array (FPGA).

As described above, the hardware configuration of the living body determination apparatus 100 includes hardware constituent elements similar to the hardware constituent elements mounted on a personal computer (PC).

Thus, various functions implemented by the living body determination apparatus 100 can be implemented as software operating on a PC. The CPU 101 executes a program so that various functions of the living body determination apparatus 100 and the below-described flowcharts can be implemented. The living body determination apparatus 100 captures a moving image of the user performing a motion in accordance with a motion instruction and executes living body determination based on the captured moving image, and therefore the living body determination apparatus 100 is also referred to as an image processing apparatus.

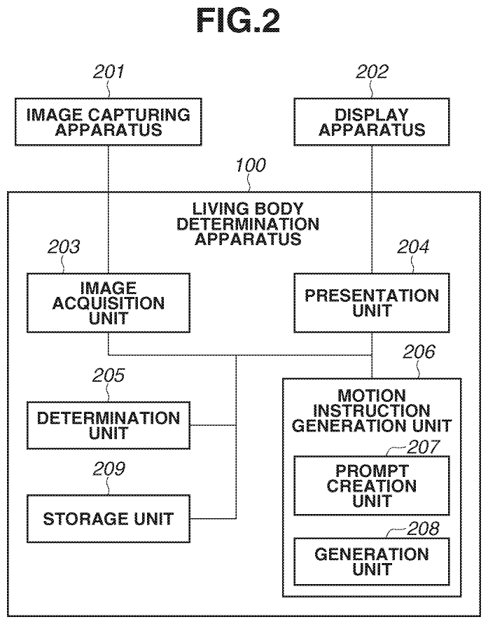

FIG. 2 is a block diagram illustrating an example of a functional configuration of the living body determination apparatus 100 according to the present embodiment.

Respective blocks illustrated in FIG. 2 can be implemented by an element such as a CPU of a computer and a mechanical device in terms of hardware, and can be implemented by a computer program in terms of software. In FIG. 2, functional blocks cooperatively implemented by the hardware and the software are illustrated. The living body determination apparatus 100 does not always have to include all of the functions illustrated in FIG. 2. For example, in a case where all or a part of a function is implemented by another device mutually connected via the network 108, the living body determination apparatus 100 does not have to include such a function.

The living body determination apparatus 100 includes an image acquisition unit 203, a presentation unit 204, a determination unit 205, a motion instruction generation unit 206, and a storage unit 209. The motion instruction generation unit 206 includes a prompt creation unit 207 and a generation unit 208. Further, the living body determination apparatus 100 is connected to an image capturing apparatus 201 and a display apparatus 202 via the network 108. In addition, the living body determination apparatus 100 may be connected to the image capturing apparatus 201 and the display apparatus 202 via input/output interfaces included in the input device 106 and the output device 107 instead of being connected via the network 108. Furthermore, the image capturing apparatus 201 and the display apparatus 202 may be internally included as parts of the input device 106 and the output device 107.

The image capturing apparatus 201 is an apparatus such as a camera, a smartphone, or a tablet terminal, having an image capturing function. The image capturing apparatus 201 captures an image of a user to be a target of living body determination, and transmits the image to the living body determination apparatus 100 via the network 108. The image can be captured as a moving image in an optional format such as Motion JPEG or H.264, or a still image in an optional format such as JPEG. In addition, the image capturing apparatus 201 may be an apparatus that is the same as the below-described display apparatus 202. For example, the image capturing apparatus 201 and the display apparatus 202 are the same apparatus in a case where the user wants to use an administration system by using a device such as a smartphone owned by the user.

The display apparatus 202 is a display apparatus such as a display or a tablet apparatus. The display apparatus 202 displays information presented by the presentation unit 204 to the user.

The image acquisition unit 203 acquires an image from the image capturing apparatus 201 via the network 108.

The presentation unit 204 presents information such as a motion instruction to the user via the display apparatus 202.

The determination unit 205 determines whether the user is a living body based on the acquired image. A specific determination method according to the present embodiment is described below with reference to a flowchart.

The motion instruction generation unit 206 generates a motion instruction to be presented to the user. The motion instruction generation unit 206 includes the prompt creation unit 207 and the generation unit 208. In addition, another constituent element can be used as long as it is possible to generate a motion instruction presented to the user. For example, a trained generative model that receives a random number as an input and outputs text describing a motion instruction in accordance with the input may be used as the motion instruction generation unit 206.

The prompt creation unit 207 creates a prompt to be input to the generation unit 208 to make the generation unit 208 generate a motion instruction.

The generation unit 208 generates a motion instruction based on the prompt having been input to the generation unit 208. In the present embodiment, the generation unit 208 generates a motion instruction by using a trained large language model. In addition, the generation unit 208 may be arranged on another device (e.g., on a network cloud) mutually connected via the network 108, and functions of the generation unit 208 may be used by communicating with the other device via the network 108. In this case, the motion instruction generation unit 206 inputs a prompt created by the prompt creation unit 207 to the generation unit 208 via the network 108. The generation unit 208 generates a motion instruction as an output in accordance with the prompt, and outputs the motion instruction to the motion instruction generation unit 206 via the network 108. In addition, a trained model that generates a motion instruction is referred to as a first trained model.

The storage unit 209 is a function unit for storing information. The storage unit 209 temporarily stores inputs and outputs of respective function units. Further, as necessary, the storage unit 209 may store, as a history of living body determination, information about a user who has executed living body determination, information about a motion instruction used for the living body determination, and information about a determination result in association with each other for a long time.

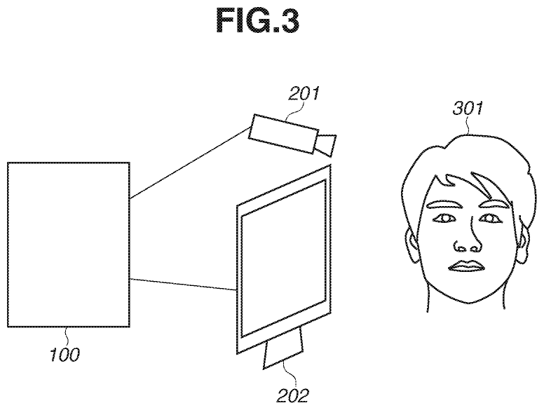

FIG. 3 is a conceptual diagram illustrating a state where a user uses the living body determination apparatus 100 according to the present embodiment. A user 301 performs a motion in accordance with a motion instruction presented by the living body determination apparatus 100 via the display apparatus 202. The living body determination apparatus 100 acquires a captured moving image of the user 301 via the image capturing apparatus 201. Further, the living body determination apparatus 100 determines whether the user 301 has succeeded in the instructed motion based on the captured moving image of the user 301. In a case where it is determined that the user 301 has succeeded in the motion, the user 301 is recognized as a living body. In a case where it is determined that the user has not succeeded in the motion, the user 301 is not recognized as a living body.

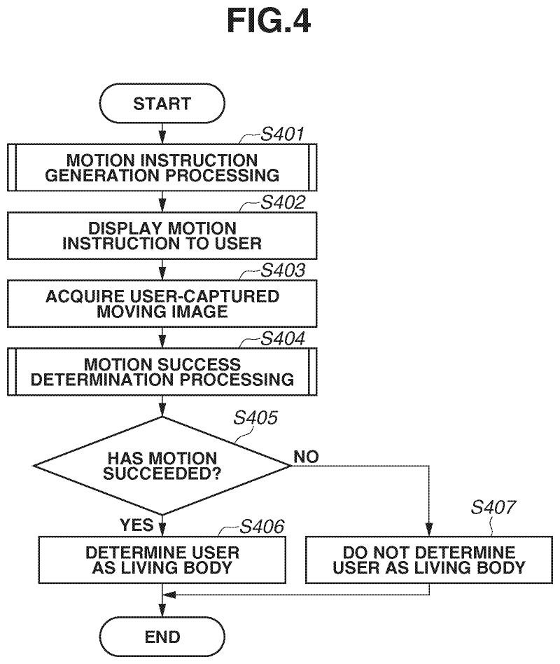

FIGS. 4 to 6 are flowcharts illustrating processing executed by the living body determination apparatus 100 according to the present embodiment. A flow of living body determination processing is described with reference to these flowcharts. However, the living body determination apparatus 100 does not always have to execute all of the steps described in the flowcharts.

FIG. 4 is a flowchart illustrating living body determination processing executed by the living body determination apparatus 100. The living body determination processing starts when information that triggers the living body determination processing is input to the living body determination apparatus 100. For example, the triggering information can be information indicating an operation of the user 301 performed on a user interface (UI) illustrating living body determination, displayed on the display apparatus 202. Specifically, an input for selecting a living body determination button is the triggering information. Alternatively, the living body determination processing may be started in a case where personal information, such as My Number Card information, is input to the living body determination apparatus 100. In addition, input of the triggering information is not essentially required for the living body determination processing. For example, the living body determination processing may be started when facial authentication processing separately executed by the living body determination apparatus 100 is completed.

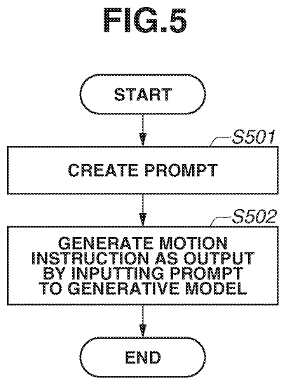

In step S401, the motion instruction generation unit 206 generates a motion instruction presented to the user. The processing is described below more specifically with reference to the flowchart in FIG. 5. Through the above processing, a motion instruction, such as “Please tap your head three times with your right hand while covering your right eye with your left hand”, is generated in text.

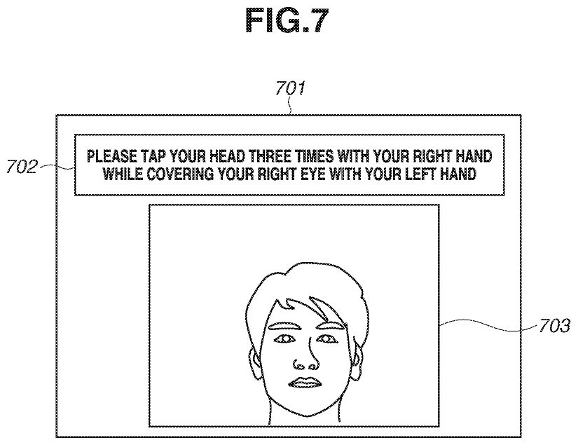

In step S402, the presentation unit 204 presents the motion instruction to the user. For example, the presentation unit 204 may execute control for displaying an interface illustrated in FIG. 7 on the display apparatus 202. A screen 701 in FIG. 7 is a screen displayed on the display apparatus 202. A motion instruction presented by the presentation unit 204 in step S402 is displayed on a window 702. An image 703 is a captured image of the user acquired by the image acquisition unit 203 in step S403 described below. In order to make the captured image appear as a mirrored image to the user, the presentation unit 204 may horizontally invert the captured image of the user. It can also be said that a user-captured moving image is displayed as the image 703 because the captured image acquired by the image acquisition unit 203 is displayed continuously. Further, with respect to a presentation method of the motion instruction, an optional method can also be employed depending on various conditions such as an intended purpose or restrictions on the system. For example, a presentation method without using the display apparatus 202 or a presentation method for presenting a motion instruction through a sound may also be employed. The user performs a motion in accordance with the presented motion instruction.

In step S403, the image acquisition unit 203 acquires a user-captured moving image.

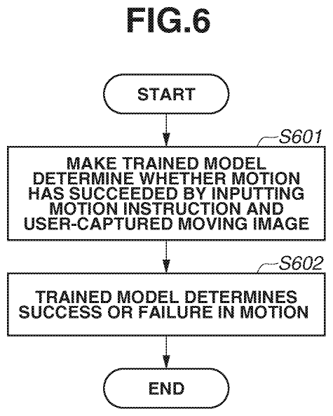

In step S404, based on the user-captured moving image, the determination unit 205 determines whether the user has succeeded in the instructed motion. The processing is specifically described below with reference to the flowchart in FIG. 6.

In step S405, the living body determination apparatus 100 determines whether the motion performed by the user is determined to be successful in step S404. In a case where the motion is determined to be successful (YES in step S405), the processing proceeds to step S406. In a case where the motion is not determined to be successful (NO in step S405), the processing proceeds to step S407.

In step S406, as a result of living body determination, the living body determination apparatus 100 determines that the user is a living body. In the actual system, processing such as processing for presenting a result to the user and processing for transmitting a result to a cooperating authentication system may additionally be executed depending on the purpose of living body determination.

In step S407, as a result of living body determination, the living body determination apparatus 100 does not determine that the user is a living body. In the actual system, after the result is presented to the user, processing for asking the user to perform living body determination again may be executed additionally. Further, in a case where the user has failed in living body determination consecutively or more than once, the living body determination apparatus 100 may not execute the living body determination processing for a certain period of time.

FIG. 5 is a flowchart illustrating motion instruction generation processing. Specifically, this flowchart illustrates processing executed in step S401, when the motion instruction generation unit 206 generates a motion instruction presented to the user.

In step S501, the prompt creation unit 207 creates a prompt to be input to the generation unit 208. For example, the prompt creation unit 207 creates a prompt such as: “As a countermeasure against impersonation in facial authentication, please generate text instructing a user to perform a motion which satisfies the following conditions: Condition 1: The motion should be complicated or unique, Condition 2: The motion can be completed within a short period (within 10 sec.), and Condition 3: The motion should be clearly seen from a camera. Please generate a new motion which satisfies these conditions. For example, please generate text such as “Tap your right shoulder with your left hand while touching your left ear with your right hand.”, “After closing your eyes and opening your mouth wide for 3 sec., then open your eyes and give a wink.”, and “After shaking your head from side to side three times, then cover your face with both hands”. Further, please provide only a piece of text describing a motion instruction, which can be displayed as is as a motion instruction to the user”.

As described in the above example, by including conditions of motion instructions to be created in a prompt, it is possible to generate a motion instruction that is easily used for living body determination. For example, as described in the condition 1, by specifying a condition that the motion should be complex or unique, it is possible to generate a motion instruction for reducing occurrence of impersonation. Further, as described in the condition 2, by specifying a condition for restricting time taken to complete a motion, it is possible to generate a motion instruction which requires little time to conduct living body determination. Further, as described in the condition 3, by specifying a condition that a motion should be clearly seen from a camera, it is possible to generate a motion instruction which makes it possible to determine success/fail in the motion based on the user-captured moving image.

A designer may design the living body determination apparatus 100 to make the prompt creation unit 207 create the same prescribed prompt every time, or to make the prompt creation unit 207 dynamically create a prompt depending on conditions. As an example of the method for dynamically creating a prompt, the motion instruction generation unit 206 may create a prompt including a motion that the user has succeeded or failed in the past. In this way, a motion instruction which allows the user to easily succeed in the motion can be generated. This example is based on a condition that the living body determination apparatus 100 can access an authentication history of a specific user through facial authentication using a facial image or personal authentication using an individual number input by the user prior to living body determination. For example, an instruction of a motion similar to the motion the user has succeeded in the past can be generated by adding the text “Please generate a motion similar to a motion of ”turning the user's head to the right while putting the user's left hand on the user's left cheek“, because the user has succeeded in such a motion in the past.” to the above-described example of the prompt. As a prerequisite, it is necessary that the living body determination system can identify a user in cooperation with the facial authentication system and acquire a history of a motion instruction and a determination result of the living body determination the user has executed in the past.

Further, the living body determination apparatus 100 may create a prompt by using information indicating an individual by acquiring a facial image and authenticating the individual through facial authentication prior to living body determination. In a case where a facial image is acquired, the image acquisition unit 203 acquires the facial image before living body determination processing is started. For example, information indicating an individual includes a gender, a facial feature, a religion, and a domicile of the individual. The facial feature may include a location of a mole in the face. Specifically, the living body determination apparatus 100 includes a text describing a motion of touching the mole in the prompt by using the location of the mole. In this way, a prompt is dynamically generated depending on the individual (authentication target), so that content of the motion instruction can dynamically be generated depending on the individual. Further, since a motion instruction can dynamically be generated depending on the individual by combining a plurality of individual features, an impersonator cannot easily generate a fake image for impersonation.

Further, in a case where the generation unit 208 can interactively generate a text and the motion instruction generation unit 206 has previously instructed the generation unit 208 to generate a motion instruction with the prompt in the above-described example, the motion instruction generation unit 206 may create a prompt for instructing the generation unit 208 to newly generate another motion instruction. For example, the motion instruction generation unit 206 may create a prompt such as “Please provide another motion instruction”. Further, in order to maintain high security, the motion instruction generation unit 206 may additionally create a prompt requesting not to generate a motion instruction similar to motion instructions used in a certain number of past living body determinations. For example, the motion instruction generation unit 206 may create a prompt such as “Please provide another motion instruction. But do not provide an instruction similar to ten motion instructions provided in the past”.

In step S502, the motion instruction generation unit 206 inputs the prompt to the generation unit 208 and acquires a motion instruction as an output. For example, a text such as “Please tap your head three times with your right hand while covering your right eye with your left hand” can be acquired as the motion instruction.

FIG. 6 is a flowchart illustrating determination processing for determining whether a motion according to the present embodiment has been performed. Specifically, this flowchart illustrates the processing executed in step S404, when the determination unit 205 determines whether the user has performed the instructed motion.

In step S601, the determination unit 205 makes a trained model determine whether a person in the user-captured moving image performs a motion in accordance with a motion instruction by inputting the motion instruction and the user-captured moving image to the trained model. The trained model is a trained model trained to determine whether a motion conforms to a motion instruction described in a natural language by interpreting a motion based on a moving image. Specifically, the trained model can be a model trained with a multimodal learning method to be capable of interpreting a moving image based on a trained large language model handling natural languages. In the multimodal learning method, for example, a moving image is vectorized by using the convolutional neural network (CNN) or the recurrent neural network (RNN). Then, the vectorized moving image is input to a transformer model for a natural language. Herein, using a CNN trained to estimate a human pose for the sake of vectorizing a moving image can be considered in order to interpret a motion. Then, the transformer model is trained to determine whether a person in the moving image performs a motion in accordance with a motion instruction based on the input of the vectorized moving image and the motion instruction. In this way, multimodal learning can be performed. For example, a user-captured moving image and a text are given as the input. The text is such as “A person in the moving image performs a motion in accordance with a given motion instruction of ”Tap your head three times with your right hand while covering your right eye with your left hand“. Has the user succeeded in the instructed motion? Please reply Yes or No”. The model is trained with a sufficient number of training data to be able to correctly reply “Yes” or “No” to the given input. A trained model for determining whether the user has performed an instructed motion is referred to as a second trained model.

In step S602, as an output of the trained model, the determination unit 205 acquires a determination result describing whether the user has succeeded in the motion. Based on the input described in the above example, in a case where a reply from the trained model is “Yes”, the determination unit 205 determines that the user has succeeded in the motion. In a case where the reply is “No”, the determination unit 205 does not determine that the user has succeeded in the motion.

In a case where the determination unit 205 determines that the user has succeeded in the motion in step S602, a subject included in the user-captured moving image is determined to be a living body.

Although an example of the living body determination apparatus 100 executing only living body determination has been described in the present embodiment, the present disclosure is not limited thereto. For example, the living body determination apparatus 100 may have a facial authentication function for identifying an individual from the subjects included in the image. It is possible to establish stronger security by combining the facial authentication function and the living body determination function.

Further, in a case where it is not possible to determine whether the user has performed a motion in accordance with the motion instruction within a predetermined time after presenting the motion instruction, the model may determine that the user does not perform a motion in accordance with the motion instruction through the living body determination processing. For example, there is a possibility that the impersonator generates a fake moving image in accordance with a motion instruction by inputting the motion instruction and a pre-prepared facial image to a generative AI after the motion instruction is presented. With respect to this, it is possible to provide no time for generating a fake moving image by setting a time limit for living body determination. In a case where a time limit is set, a prescribed time may be generated by the trained model depending on the content of the motion instruction. For example, true data including a time limit (prescribed time) corresponding to the motion instruction may be used when the trained model for generating a motion instruction is trained. Then, a time limit is generated by the trained model in addition to the motion instruction when the motion instruction is created.

Through the above-described configuration and processing, it is possible to improve the countermeasures against impersonation in living body determination.

### Second Embodiment

In a second embodiment, a method for generating and presenting a moving image as a motion example to a user is described. By presenting a moving image serving as a motion example to the user, it is possible to make the user visually understand the motion even in a case where a motion instruction generated by the motion instruction generation unit 206 is difficult for the user to understand. Hereinafter, differences from the first embodiment are described.

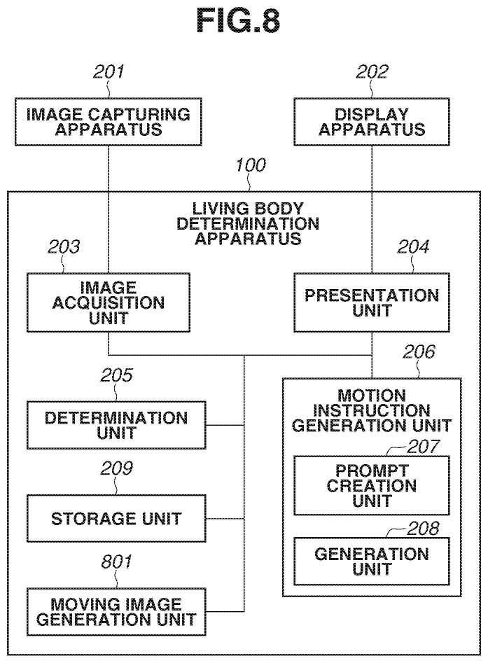

FIG. 8 is a block diagram illustrating an example of a functional configuration of the living body determination apparatus 100 in accordance with the present embodiment. The functional units 201 to 208 are similar to those described in the first embodiment.

A moving image generation unit 801 is a generation unit for creating a moving image from a text. In the present embodiment, the moving image generation unit 801 generates a moving image illustrating a motion based on a text of the motion instruction generated by the motion instruction generation unit 206. Processing for generating a moving image from the text is executed by using a trained model. For example, the trained model can be implemented by applying a technique described in Y. Liu et al., “Sora: A Review on Background, Technology, Limitations, and Opportunities of Large Vision Models”, https://arxiv.org/abs/2402.17177, 27 Feb. 2024. Specific processing according to the present embodiment executed when the moving image generation unit 801 generates a moving image illustrating a motion is described below with reference to the flowchart. In addition, a trained model for generating an example moving image is referred to as a third trained model.

In addition, the moving image generation unit 801 and some of its functions may be arranged on another device (e.g., on a network cloud) mutually connected via the network 108, and functions of the moving image generation unit 801 may be used by communicating with the other device via the network 108. For example, the moving image generation unit 801 may input a prompt to a trained model on the other device via the network 108, and the trained model may generate a moving image as an output in accordance with the prompt and output the moving image to the moving image generation unit 801 via the network 108.

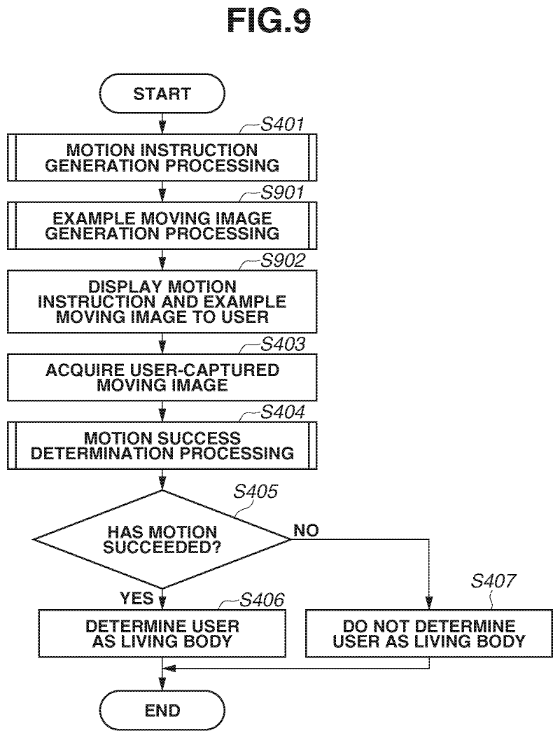

FIG. 9 is a flowchart illustrating living body determination processing in accordance with the present embodiment. The processing in steps S401, S403, and S405 to S407 is similar to the processing described in the first embodiment.

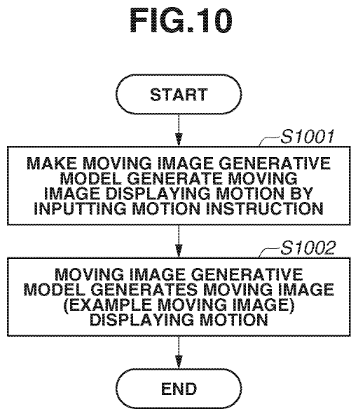

In step S901, the moving image generation unit 801 generates a moving image (example moving image) illustrating a motion, based on a motion instruction. More specific processing is described below with reference to the flowchart in FIG. 10.

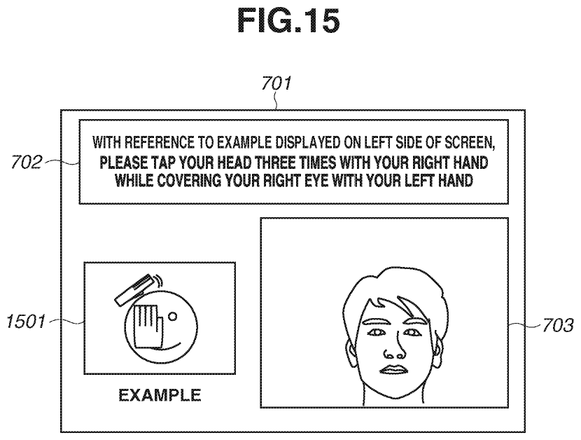

In step S902, the presentation unit 204 presents a motion instruction and an example moving image to the user. For example, an interface as illustrated in FIG. 15 may also be displayed on the display apparatus 202. A screen 701, a window 702, and an image 703 are similar to those described in the first embodiment. An example moving image 1501 generated in step S901 is displayed. In order to make the image appear as a mirrored image to the user, the presentation unit 204 may horizontally invert the example moving image 1501. In addition to displaying a motion instruction on the window 702, the presentation unit 204 may display an example moving instruction as a reference for the user to perform a motion. Further, the presentation unit 204 may display only an example moving image as a reference for the user to perform a motion, without displaying text of the motion instruction on the window 702.

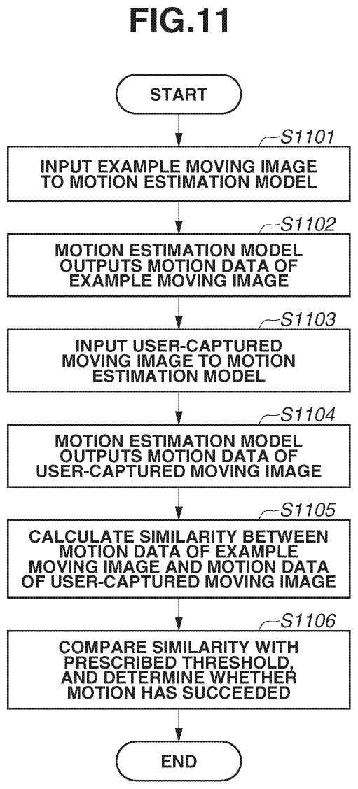

In step S404, the determination unit 205 compares a motion captured in the user-captured moving image and a motion captured in the example moving image, and determines that the user has succeeded in the motion in a case where the motions are similar to each other. The processing is described below more specifically with reference to the flowchart in FIG. 11. In addition, the determination unit 205 may determine whether the user has succeeded in the motion through a method similar to the method described in the first embodiment or another method.

FIG. 10 is a flowchart illustrating processing for generating a moving image (example moving image) illustrating a motion based on a motion instruction, executed by the moving image generation unit 801 according to the present embodiment.

In step S1001, the moving image generation unit 801 makes a moving image generative model create a moving image illustrating a motion in accordance with a motion instruction by inputting a prompt. For example, the moving image generation unit 801 inputs a prompt such as “Please generate a moving image illustrating a person performing a motion in accordance with a motion instruction of ”Tap your head three times with your right hand while covering your right eye with your left hand“, which satisfies the following conditions, Condition 1: Composition is focused on the face, Condition 2: A motion is started with a face facing forward, and Condition 3: The face and a moving part should not be hidden except by the motion”. As described in the above conditions 1 to 3, by specifying the face-focused composition and absence of a hidden area as the conditions, it is possible to generate an example moving image easily understandable to the user.

In step S1002, the moving image generation unit 801 acquires a moving image (example moving image) illustrating a motion as an output of the moving image generative model.

FIG. 11 is a flowchart illustrating determination processing for determining whether the user has performed a motion, according to the present embodiment. Specifically, this flowchart illustrates processing in step S404 for determining whether the user has performed a motion in accordance with the motion instruction, executed by the determination unit 205.

In step S1101, the determination unit 205 inputs an example moving image to a motion estimation model. For example, the motion estimation model can be implemented by applying a technique described in Z. Cao et al., “OpenPose: Realtime Multi-Person 2D Pose Estimation using Part Affinity Fields”, https://arxiv.org/abs/1812.08008, 18 Dec. 2018.

In step S1102, the determination unit 205 acquires motion data of the example moving image as an output of the motion estimation model. The motion data can be expressed by pose information of a person for each frame. The pose information can be expressed by coordinates of the joint points of the elbow and the wrist, and coordinates of the facial organ points such as the eyes and the nose in the frame.

In step S1103, the determination unit 205 inputs the user-captured moving image to the motion estimation model.

In step S1104, the determination unit 205 acquires motion data of the user-captured moving image as an output of the motion estimation model.

In step S1105, the determination unit 205 calculates a similarity between the motion data of the example moving image and the motion data of the user-captured moving image. A similarity between the motion data can be calculated by an optional method. For example, the motion data is normalized in time and space directions. Next, with respect to a frame of the example moving image and a frame of the user moving image at the same time point, a sum of distances between the coordinates of corresponding joint points and facial organ points is calculated for all of the joint points and the facial organ points and time, and an inverse number of the sum may be acquired as a similarity. In order to calculate a similarity robust to a difference in motion timing, a similarity in a combination of frames with the highest similarity (minimum distance) may be used by employing a technique of dynamic time warping.

In step S1106, the determination unit 205 compares the similarity with a prescribed threshold, and determines whether the motion has succeeded. A large number of example moving images and user-captured moving images illustrating success and failure in the motion are prepared as a dataset. Then, a threshold with which the most appropriate determination can be made based on a distribution of similarities in success and failure in the motion in the dataset may be used as a prescribed threshold. A threshold with the highest F-number in a classification of success and failure in the motion in a dataset may be used as the threshold with which the most appropriate determination can be made, or the threshold may be determined based on another index. In a case where the similarity exceeds the threshold, the determination unit 205 determines that the user has succeeded in the motion. In a case where the similarity is the threshold or less, the determination unit 205 does not determine that the user has succeeded in the motion.

### Third Embodiment

In the second embodiment, a method for generating a moving image as a motion example has been described. In a third embodiment, a method for generating motion data of a motion is described. In the present embodiment, motion data describing a motion instructed by a motion instruction is generated first before a moving image is generated. Thereafter, a moving image as an example is generated based on the motion data. Further, determination on whether the user has succeeded in the motion is executed based on comparison with the generated motion data. Hereinafter, differences from the second embodiment are mainly described.

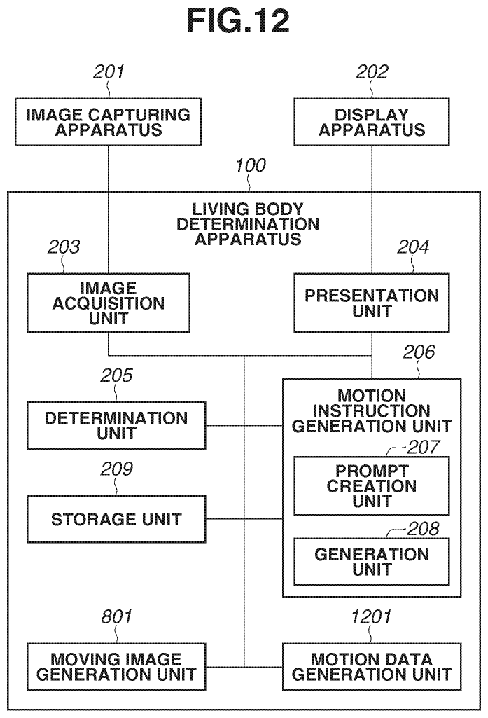

FIG. 12 is a block diagram illustrating an example of a functional configuration of the living body determination apparatus 100 according to the present embodiment. The functional units 201 to 208 are similar to those described in the first embodiment.

A moving image generation unit 801 is a generation unit for creating a moving image from motion data. In the present embodiment, the moving image generation unit 801 generates a moving image illustrating a motion, based on motion data generated by a motion data generation unit. Processing for generating a moving image from motion data is executed by using a trained model. The trained model can be implemented by applying a technique described in Y. Ma et al., “Follow Your Pose: Pose-Guided Text-to-Video Generation using Pose-Free Videos”, https://arxiv.org/abs/2304.01186, 3 Apr. 2023. Specific processing according to the present embodiment, which is executed when the moving image generation unit 801 generates a moving image illustrating a motion, is described below with reference to the flowchart.

In addition, a method for generating a moving image by manipulating a three-dimensional or two-dimensional prescribed human model to poses for each frame and rendering the frames based on the motion data may be employed, instead of the method using a trained model. Further, in a case where a moving image does not have to be generated because the presentation unit does not present a moving image illustrating a motion, the living body determination apparatus 100 does not have to include the moving image generation unit 801.

In addition, the moving image generation unit 801 and some of its functions may be arranged on another device (on a network cloud, for example) mutually connected via the network 108, and functions of the moving image generation unit 801 may be used by communicating with the other device via the network 108. For example, the moving image generation unit 801 inputs motion data to a trained model on another device via the network 108. Then, the trained model may generate a moving image as an output in accordance with the motion data and output the moving image to the moving image generation unit 801 via the network 108.

A motion data generation unit 1201 is a generation unit for creating motion data from a text. In the present embodiment, the motion data generation unit 1201 generates motion data describing a motion based on the text of the motion instruction generated by the motion instruction generation unit 206. Processing for generating a moving image from the text is executed by using a trained model. For example, the trained model can be implemented by applying a technique described in H. Ahn et al., “Text2Action: Generative Adversarial Synthesis from Language to Action”, https://arxiv.org/abs/1710.05298, 15 Oct. 2017. Specific processing according to the present embodiment, which is executed when the motion data generation unit 1201 generates motion data describing a motion, is described below with reference to the flowchart.

In addition, the motion data generation unit 1201 and some of its functions may be arranged on another device (on a network cloud, for example) mutually connected via the network 108, and functions of the motion data generation unit 1201 may be used by communicating with the other device via the network 108. For example, the motion data generation unit 1201 inputs a prompt to a trained model on another device via the network 108. Then, the trained model generates motion data as an output in accordance with the prompt, and outputs the motion data to the motion data generation unit 1201 via the network 108.

Further, the moving image generation unit 801 and the motion data generation unit 1201 may be implemented by a single entity. For example, functions of the moving image generation unit 801 and the motion data generation unit 1201 may be implemented by using a trained model that outputs both of the motion data and the moving image when a text is given as an input.

The living body determination processing according to the present embodiment is described with reference to FIG. 9. The processing in step S401 is similar to the processing described in the embodiments 1 and 2.

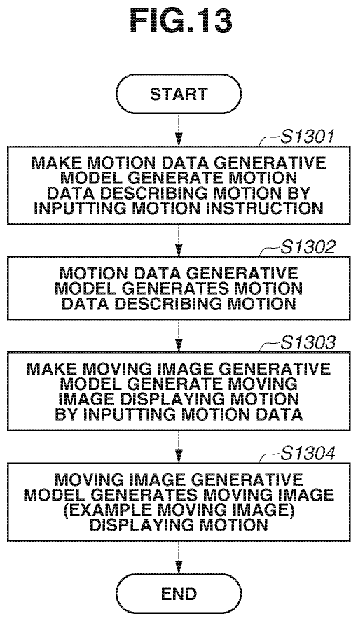

In step S901, the motion data generation unit 1201 generates motion data describing a motion based on a text of the motion instruction. Further, the moving image generation unit 801 generates a moving image illustrating a motion based on the motion data. The processing is described below more specifically with reference to the flowchart in FIG. 13.

The processing in step S902 is similar to the processing described in the second embodiment.

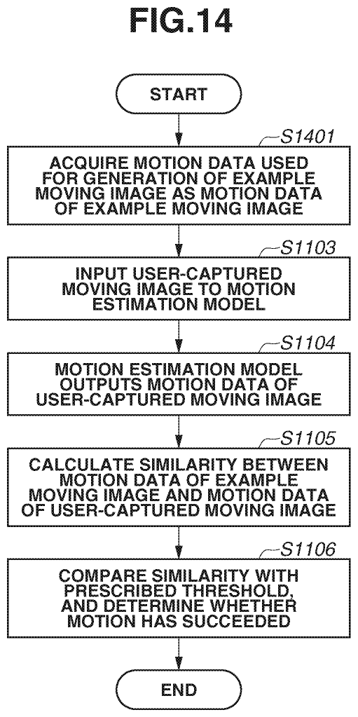

In step S404, the determination unit 205 compares a motion captured in the user-captured moving image and a motion captured in the example moving image, and determines that the user has succeeded in the motion in a case where the motions are similar to each other. As a motion captured in the example moving image, motion data is used that has been generated by the motion data generation unit 1201 based on the motion instruction. The more specific processing is described below with reference to the flowchart in FIG. 14. In addition, the determination unit 205 may determine whether the user has succeeded in the motion through a method similar to the method described in the embodiments 1 and 2 or another method.

The processing in steps S405 to S407 is similar to that described in the embodiments 1 and 2.

FIG. 13 is a flowchart illustrating processing executed in step S901, when the motion data generation unit 1201 generates motion data, and the moving image generation unit 801 further generates a moving image.

In step S1301, the motion data generation unit 1201 makes a motion data generative model create motion data describing a motion instructed by a motion instruction by inputting a prompt. For example, the motion data generation unit 1201 inputs a prompt such as “Please generate motion data describing a person performing a motion in accordance with a motion instruction of ”Tap your head three times with your right hand while covering your right eye with your left hand“, which satisfies the following conditions, Condition 1: Composition is focused on the face, Condition 2: A motion is started with a face facing forward, and Condition 3: The face and a moving part should not be hidden except by the motion”. As the motion data, the motion data generative model outputs coordinates of the respective parts (e.g., joint points and facial organ points) of a human body performing a motion in accordance with an input, included in a two-dimensional image captured from an imaging viewpoint at each time. As described in the above conditions 1 to 3, by specifying the face-focused composition and absence of a hidden area as the conditions, it is possible to generate motion data close to a moving image captured when the user performs a motion toward the image capturing apparatus 201.

In step S1303, the moving image generation unit 801 makes a moving image generative model create a moving image of a person performing a motion based on the motion data by inputting a prompt. A reference image that illustrates an appearance of a person performing a motion may be provided as necessary. Further, text may be provided as a prompt, such as “Please generate a moving image of a person in the reference image that is performing a motion described in the motion data, make the motion look natural and realistic, and make the motion conform to the pose described in the motion data”, as necessary.

In step S1304, the moving image generation unit 801 acquires, as an output of the moving image generative model, a moving image (example moving image) of a person performing a motion based on the motion data.

FIG. 14 is a flowchart illustrating determination processing for determining whether the user has performed a motion, according to the present embodiment. Specifically, this flowchart illustrates the processing in step S404 for the determination unit 205 to determine whether the user has succeeded in the motion.

In step S1401, the determination unit 205 acquires motion data of an example moving image as an output of the motion estimation model. For the motion data, motion data that has been generated by the motion data generation unit 1201 based on the motion instruction in step S1302 is used.

The processing in steps S1103 to S1106 is similar to the processing described in the second embodiment.

### Fourth Embodiment

In the embodiments 1 to 3, a motion instruction is generated when the user executes living body determination. In a fourth embodiment, a motion instruction is generated and stored previously, and the stored motion instruction is read when the user executes living body determination. In a case where computational resources are not sufficient, it will take a long time to generate a moving image. In this case, there is a possibility that the user has to wait when the user executes living body determination, particularly, when the user generates a moving image used as an example described in the embodiments 2 and 3. By previously generating a motion instruction and a moving image used as an example, it is possible to allow the user to execute living body determination without waiting. Hereinafter, differences from the third embodiment are mainly described.

In addition, a functional configuration of the living body determination apparatus 100 according to the present embodiment is similar to the functional configuration described in the third embodiment.

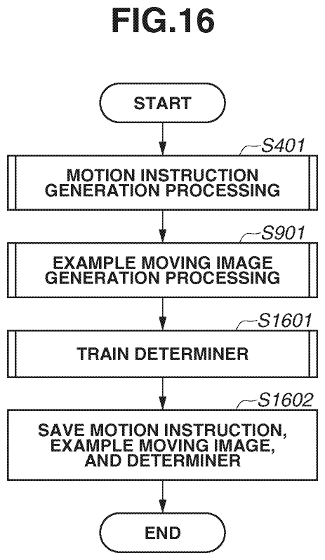

FIG. 16 is a flowchart illustrating motion instruction generation processing according to the present embodiment.

In step S401, the motion instruction generation unit 206 generates a motion instruction to be presented to the user. Specific processing is similar to the processing described in the embodiments 1 to 3.

In step S901, the motion data generation unit 1201 generates motion data describing a motion based on a text of the motion instruction. Based on the motion data, the moving image generation unit 801 generates a moving image (example moving image) illustrating a motion. Specific processing is similar to the processing described in the third embodiment. If it is necessary to use motion data and moving images as a dataset when training is executed in step S1601, a plurality of pieces of motion data and moving images may be generated with respect to one motion instruction by executing the processing in step S901 for a plurality of times. Further, in a case where only motion data is used for the training, generation of motion data may be executed for a plurality of times, while generation of a moving image is executed only one time.

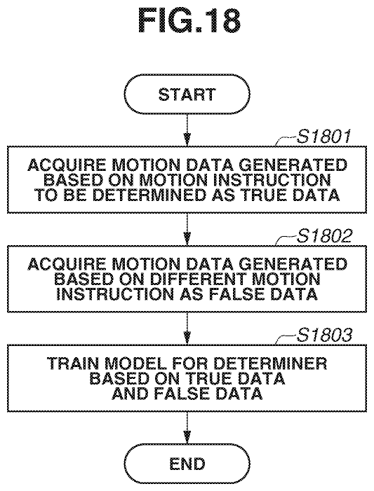

In step S1601, the determination unit 205 trains a determiner for determining whether the user has succeeded in the motion instructed in the motion instruction generated in step S401. The more specific processing is described below with reference to the flowchart in FIG. 18.

In step S1602, the living body determination apparatus 100 stores a motion instruction, an example moving image, and a determiner in the storage unit 209 in association with each other. As necessary, other information such as motion data may also be stored in association with each other. Further, in a case where a motion instruction for a specific user is generated in step S401, the motion instruction may be stored in association with information about that user (e.g., user's name and ID).

The living body determination apparatus 100 executes the processing for generating a motion instruction illustrated in FIG. 16 at an optional timing, and the number of motion instructions to be generated is optional. For example, in an implementation in which the motion instruction used once (presented to the user once) is not used again, the number of motion instructions same as the number of motion instructions used in the previous day may be generated and stored every morning. Alternatively, one or more motion instructions are generated every hour, and a prescribed motion instruction or a motion instruction randomly selected from the generated motion instructions may be presented in the following hour. In this case, there is a possibility that a motion instruction used once is reused within an hour, so that a level of security against impersonation becomes lowered in comparison to the case where a different motion instruction is used every time. It is advisable to evaluate to what extent reuse of the same operation instruction is allowed, and to decide a generation timing and the number of motion instructions to be generated, depending on the computational resources of the system and a security level for the use case.

FIG. 18 is a flowchart illustrating processing for training a determiner for determining whether the user has performed a motion, according to the present embodiment. Specifically, this flowchart illustrates the processing executed in step S1601, when the determination unit 205 trains a determiner for determining whether the user has succeeded in the motion.

In step S1801, the determination unit 205 acquires the motion data generated in step S901 with respect to the motion instruction generated in step S401. A plurality of pieces of motion data may be acquired in a case where a plurality of pieces of motion data is generated in step S901. The motion data acquired in step S1801 is added to the dataset as true data.

In step S1802, the determination unit 205 acquires the motion data generated in step S901 through the processing for generating a motion instruction other than the motion instruction generated in step S401. The determination unit 205 may acquire a plurality of pieces of motion data for a plurality of other motion instructions as necessary. The motion data acquired in step S1802 is added to the dataset as false data. Further, the determination unit 205 may acquire other data if the data can be used as false data. For example, the determination unit 205 may store motion data acquired from the user-captured moving image when another motion instruction is presented, and may acquire that motion data as false data.

In step S1803, the determination unit 205 trains a determiner for determining whether the user has succeeded in the instructed motion by using the dataset created in steps S1801 and S1802. For example, by using an algorithm such as deep learning or support vector machine (SVM), a learner that receives motion data as an input and outputs a determination result indicating whether the instructed motion has succeeded can be implemented as the determiner.

Through the method described in FIG. 18, a determiner for receiving the motion data as an input to determine whether the user has succeeded in the instructed motion is trained. However, the determiner for receiving other data as an input may also be trained. For example, a determiner implemented by the convolutional neural network (CNN) or the recurrent neural network (RNN) may be trained by using a moving image (example moving image) illustrating a generated motion as an input.

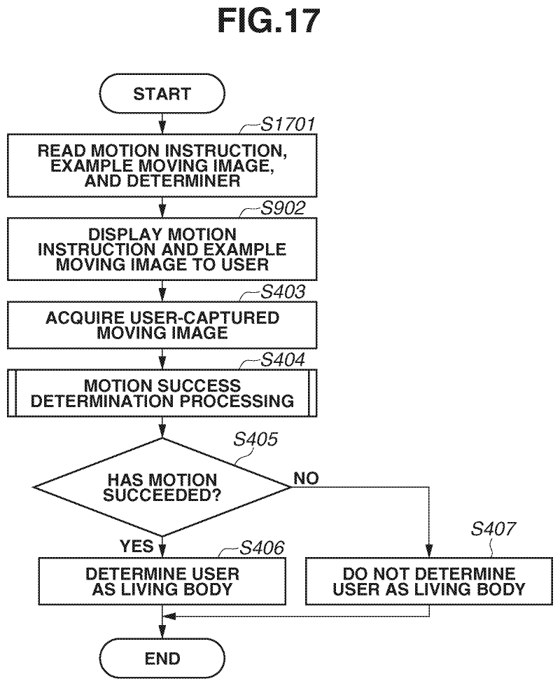

FIG. 17 is a flowchart illustrating living body determination processing according to the present embodiment. Specifically, this flowchart illustrates the processing executed when the user requests the living body determination apparatus 100 to execute living body determination.

In step S1701, the living body determination apparatus 100 reads the motion instruction, the example moving image, and the determiner stored in step S1602 from the storage unit 209. Various methods can be employed for specifying which motion instruction is read from among the stored instructions. For example, when the living body determination apparatus 100 can identify a user who has requested living body determination in a state where a motion instruction stored in association with information about that user is present, the living body determination apparatus 100 may read that motion instruction. Alternatively, the living body determination apparatus 100 may read a motion instruction generated the earliest from among the stored motion instructions, or may read a motion instruction decided randomly. The read motion instruction may be deleted from the storage unit 209 in the implementation in which the same motion instruction is not used again.

The processing in steps S902 and S403 is similar to the processing described in the third embodiment.

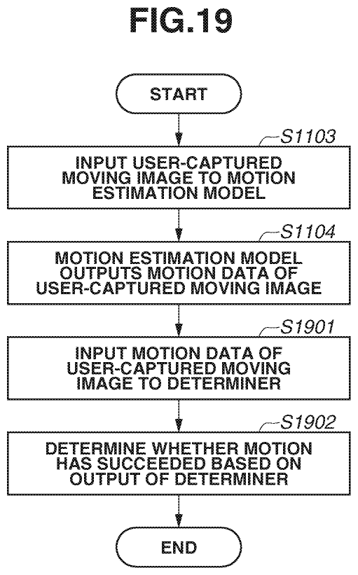

In step S404, the determination unit 205 determines whether the user has succeeded in the motion by using the determiner read in step S1701. The processing is described below more specifically with reference to the flowchart in FIG. 19. In addition, the determination unit 205 may determine whether the user has succeeded in the motion through a method similar to the methods described in the embodiments 1 to 3 or another method.

The processing in steps S405 to S407 is similar to the processing described in the embodiments 1 to 3.

FIG. 19 is a flowchart illustrating determination processing for determining whether the user has performed a motion, according to the present embodiment. Specifically, this flowchart illustrates the processing executed in step S404, when the determination unit 205 determines whether the user has succeeded in the motion.

The processing in steps S1103 and S1104 is similar to the processing described in the third embodiment.

In step S1901, the determination unit 205 inputs motion data of the user-captured moving image to the determiner read in step S1701.

In step S1902, the determination unit 205 acquires, as an output of the determiner, a determination result describing whether the user has succeeded in the motion.

As described in FIG. 18, a determiner for receiving a feature other than the motion data as an input may be used. In this case, in step S404, the determination unit 205 acquires a feature as an input for the determiner, and acquires a result by inputting the feature to the determiner. For example, a determiner trained by inputting example moving images as inputs may be used. In this case, in step S404, the determiner receives a user-captured moving image as an input.

### Other Embodiments

Although the present embodiments have been described in detail, the present disclosure can be implemented in various forms, such as a system, an apparatus, a method, a program, and a recording medium (storage medium). Specifically, the present disclosure may be applied to a system consisting of a plurality of devices (for example, a host computer, an interface device, an image capturing apparatus, and a Web application), or may be applied to an apparatus consisting of a single device.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-069035, filed Apr. 18, 2025, which is hereby incorporated by reference herein in its entirety.

What is claimed is:

1. An image processing apparatus comprising:
one or more memories storing instructions; and
one or more processors for executing the instructions to:
acquire a facial image including a face of a subject;
execute authentication processing for identifying an individual by using the facial image;
present a motion instruction generated by using a first trained model;
acquire a moving image including the subject after presenting the motion instruction;
determine, as a first determination, that the subject has performed a motion in accordance with the motion instruction using the motion instruction and the moving image including the subject; and
determine, as a second determination, that the subject included in the moving image is not a fake after authenticating that the subject is a pre-registered individual by performing authentication processing that uses the facial image of the subject when it is determined, in the first determination, that the subject has performed the motion in accordance with the motion instruction.

2. The image processing apparatus according to claim 1, wherein the motion instruction is generated by inputting information about the individual identified through the authentication processing to the first trained model.

3. The image processing apparatus according to claim 2, wherein the information about the individual is at least one or more of a gender, a feature of a face, a religion, a domicile, and a past authentication history.

4. The image processing apparatus according to claim 1, wherein the first determination determines that the subject has performed the motion in accordance with the motion instruction by inputting the moving image including the subject to a second trained model.

5. The image processing apparatus according to claim 1, wherein the first trained model is a large language model (LLM).

6. The image processing apparatus according to claim 1, wherein the one or more processors execute the instructions to further:
generate a moving image of the motion instruction based on the motion instruction; and
present the moving image of the motion instruction.

7. The image processing apparatus according to claim 6, wherein the moving image of the motion instruction is generated by inputting the motion instruction to a third trained model.

8. The image processing apparatus according to claim 1, wherein the first determination determines that the subject does not perform the motion in accordance with the motion instruction when the first determination is not completed within a predetermined time after presenting the motion instruction.

9. An image processing method comprising:
acquiring a facial image including a face of a subject;
executing authentication processing for identifying an individual by using the facial image;
presenting a motion instruction generated by using a first trained model;
acquiring a moving image including the subject after presenting the motion instruction;
determining, as a first determination, the subject has performed a motion in accordance with the motion instruction using the motion instruction and the moving image including the subject; and
determining, as a second determination, that the subject included in the moving image is not a fake after authenticating that the subject is a pre-registered individual by performing authentication processing that uses the facial image of the subject when it is determined, in the first determination, that the subject has performed the motion in accordance with the motion instruction.

10. A non-transitory computer-readable storage medium storing a program for causing a computer to execute a control method of an image processing apparatus comprising:
acquiring a facial image including a face of a subject;
executing authentication processing for identifying an individual by using the facial image;
presenting a motion instruction generated by using a first trained model;
acquiring a moving image including the subject after presenting the motion instruction;
determining, as a first determination, that the subject has performed a motion in accordance with the motion instruction using the motion instruction and the moving image including the subject;
determining, as a second determination, that the subject included in the moving image is not a fake after authenticating that the subject is a pre-registered individual by performing authentication processing that uses the facial image of the subject when it is determined, in the first determination, that the subject has performed the motion in accordance with the motion instruction.
